(19) United States
(12) Patent Application Publication
(10) Pub. No.: US 2026/0288746 A1
(43) Pub. Date: Sep. 24, 2026

(54) CENTRALIZED PAYER DIRECTORY SYSTEM

(71) Applicant: Oracle International Corporation, Redwood Shores, CA (US)

(72) Inventors: Mohammad Ahmed Memon, Seattle, WA (US); Amit Alon, Belmont, CA (US); Jeffrey Trent, Altamonte Springs, FL (US); Sanghamitra Das, Kansas City, MO (US)

(73) Assignee: Oracle International Corporation, Redwood Shores, CA (US)

(21) Appl. No.: 19/412,435

(22) Filed: Dec. 8, 2025

Related U.S. Application Data
(60) Provisional application No. 63/774,688, filed on Mar. 19, 2025.

(51) Int. Cl. G06F 16/25; G06F 16/215; H04L 9/40; G06F 16/248

(52) U.S. Cl. CPC G06F 16/252; G06F 16/215; H04L 63/08; G06F 16/248

(57) ABSTRACT

The present disclosure relates to centralized resource identification techniques, leveraging a standardized resource directory for storing resource information in a cloud network. The centralized resource identification techniques may be provided for creating a data ingestion layer to store and map data that may include mapping a resource ID to a server endpoint in a meta database, parsing the data to detect duplicate resources, validating the data, defining multiple APIs for the resources, registering errors, and updating the APIs. The techniques may reroute the requests from one server endpoint to another by receiving the request from a user, authenticating the request at an API gateway, retrieving an API of a resource associated with the request, and rerouting the request based on associated mapping and policies. The request processing may be automated using a machine learning engine, and one or more resources and their services may be displayed on a user interface.

### CROSS-REFERENCE TO RELATED APPLICATIONS

This application claims the benefit of U.S. Provisional Patent Application No. 63/774,688 filed on March 19, 2025. The entire disclosure of the aforementioned application is incorporated by reference herein in its entirety for all purposes.

### BACKGROUND

Healthcare providers require payer and health plan information to ensure accurate billing, efficient claims processing, and optimal patient care. The payer information may involve an encrypted identifier of a payer that can be usually registered in the providers’ databases hosted at computer systems either on-premises or in a cloud. Typical services provided by the payer may include various processes for claims submission, preauthorization requirements, and a network of approved healthcare providers. The health plan information may encompass a patient’s insurance policy number, the name of the payer, and the type of health plan (e.g., HMO, PPO, EPO). It may also include coverage details such as co-pays, deductibles, and out-of-pocket maximums, as well as a list of covered services including exclusions or limitations, if applicable. This information helps providers verify patient eligibility, understand coverage details, and determine the appropriate reimbursement rates for services rendered. Additionally, having comprehensive payer information may allow healthcare organizations/providers to coordinate healthcare more effectively, reduce administrative burdens, and improve overall patient satisfaction by minimizing billing errors and delays.

Traditionally, identifying and routing payer information involved manual processes and paper-based systems. Healthcare providers would collect insurance details from patients, verify coverage through phone calls or emails, and manually enter the gathered information into their billing systems. This method is time-consuming and prone to errors, leading to delays in processing claims and increased administrative costs. Moreover, the payer information is scattered, uncoordinated, and decentralized. Providers and clearinghouse staff struggle to identify a payer, and the routing information is needed for electronic information exchange because payers are typically referred by different names between organizations. Clients use local payer directories to help them manage all variations in the names of prayers for requesting patient insurance eligibility and knowing what procedures require authorization.

The lack of a national definition of a payer along with the lack of a codified federal payer identifier may result in delays in identifying and onboarding payers for using electronic financial transactions. According to the 2023 CAQH Index Report, the result of delayed implementation of a complete electronic 835 remittance exchange, industry wide, cost payers $38M and providers $663M annually in costs associated with staff using web portals, interactive voice responses systems, telephone, mail, fax, and email. The lack of uniformity of payer names and payer identifiers for an electronic data interchange (EDI) clearinghouse may also contribute to a cumbersome process.

In addition to defining payers, clearinghouses may also require customers to manually build and configure payers that are specifically contracted by their providers. This results in an additional 15 minutes of payer maintenance for every new payer that a provider wishes to configure for electronic financial transactions. Payer information and requirements frequently change, resulting in update overheads for healthcare organizations and associated high costs of maintaining payer information within a financial data exchange and other health systems. To overcome these issues, a centralized directory having standardized payer information may be employed. Specifically, an automated system that can address the issues related to time management and cost optimization, and that can make the entire process more streamlined, allowing faster and accurate routing of payer information.

### SUMMARY

Certain aspects and features of the present disclosure relate to centralized resource identification techniques leveraging a standardized resource directory for storing resource information in a cloud network. The cloud network has a cloud infrastructure that can handle one or more tenants. A resource is an entity that can provide financial protection or reimbursement to individuals and organizations against losses from specific risks or contingencies. The resource information may include name, location, and/or an encrypted identifier of various resources being used across one or more tenancies. The centralized resource identification techniques may be provided for creating a data ingestion layer to store and map data. Creating the data ingestion layer may include mapping a resource ID to a server endpoint in a meta database, parsing the data to detect duplicate resources, and validating the data. The server endpoint is an entity that acts as an intermediary between an organization (i.e., clinics, hospitals, banks, etc.) and the resource to perform initial checks for errors and inconsistencies in the data before submission, which helps in minimizing delays and improving the overall efficiency of the billing process.

Creating the data ingestion layer may further include defining application programming interfaces (APIs) for resources, registering multiple errors, and updating APIs. The one or more errors may include wrong credential information, payers with conflicting policies, etc. The one or more errors may be registered as follow up actions for a user. The techniques may further reroute the requests from a first server endpoint to a second server endpoint by receiving a request from a user, authenticating the request at an API gateway, retrieving an API of a resource associated with the request, and retrieving mapping and one or more policies associated with the request from the meta database. In another aspect, the meta database can be a directory that handles automated transaction processing at the cloud network. The techniques may further involve rerouting the request based on the mapping and one or more policies and returning a response to the server endpoint. The response may include exchanging credentials or financial data of the resource and/or the user with the server endpoint.

The request processing may be automated using a machine learning engine, and the one or more resources and their services may be displayed at a user interface. The user interface may allow users to choose from different server endpoints, resources within or outside of the cloud network, and their respective services. The services offered by the resource may include providing claims submission, preauthorization requirements, and a network of approved healthcare providers. In one instance, the user interface may allow the server endpoint to choose from the one or more resources working with the organization and the one or more service plans of the server endpoint. The service plans of the server endpoint may include handling pricing of offered services and tax handling, amongst other things.

In yet another aspect, the techniques mentioned in the disclosure may consolidate multiple APIs and resources that are present nation-wide, in a centralized storage or the meta database. Parsing data and detecting duplicate resources (i.e., resources registered across one or more server endpoints under same name or ID) can be done using algorithms like prefix-based search, fuzzy matching, and full string matching. In certain instances, an admin (i.e., authorized personnel) and/or the resource can manage its services by assessing the APIs stored in the meta database and by using one or more policies. In another instance, the machine learning engine may process the requests and optimize the services plans based on user preferences. The machine learning engine can make informed decisions by using the one or more policies, one or more confidence metrics, and user feedback stored in a historical database.

In some embodiments, a system is provided that includes one or more data processors and a non-transitory computer-readable storage medium containing instructions which, when executed on one or more data processors, cause the one or more data processors to perform part or all of one or more methods disclosed herein.

In some embodiments, a computer-program product tangibly embodied in a non-transitory machine-readable storage medium, including instructions configured to cause one or more data processors to perform part or all of one or more methods or processes disclosed herein.

In some embodiments, a system is provided that includes one or more means to perform part or all of one or more methods or processes disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention as claimed has been specifically disclosed by embodiments and optional features, modification and variation of the concepts herein disclosed may be resorted to by those skilled in the art, and that such modifications and variations are considered to be within the scope of this invention as defined by the appended claims.

### BRIEF DESCRIPTION OF THE DRAWINGS

The present disclosure is described in conjunction with the appended figures:

FIG. 1 shows an exemplary block diagram to illustrate a centralized resource identification system at a cloud network in accordance with some aspects of the present disclosure.

FIG. 2 shows an exemplary block diagram illustrating a data model to reroute requests of a user in accordance with some aspects of the present disclosure.

FIG. 3A shows an exemplary block diagram illustrating a data flow between an application service provider (ASP) network and a cloud infrastructure region.

FIG. 3B shows an exemplary block diagram illustrating an automated data flow between an (ASP) network and a cloud infrastructure region.

FIG. 4 illustrates an exemplary user interface (UI) for authenticated users, showing a resource directory dashboard.

FIG. 5 illustrates an exemplary user interface of an organization, showing a customer portal.

FIG. 6 illustrates an exemplary workflow for identifying resources and rerouting user’s requests to different resources in accordance with some aspects of the present disclosure.

FIG. 7 depicts a simplified diagram of a distributed system for implementing an embodiment of the present disclosure.

FIG. 8 is a simplified block diagram of a cloud system environment in accordance with certain aspects of various embodiments of the invention.

FIG. 9 illustrates an exemplary computer system that may be used to implement certain aspects of the present disclosure.

### DETAILED DESCRIPTION

The present disclosure relates to centralized resource identification techniques, leveraging a standardized resource directory, for storing resource information in a cloud network. The cloud network has a cloud infrastructure that can handle one or more tenants. The centralized resource identification techniques may provide rerouting of requests through switching APIs of resources, cost optimization, and self-service to users. The ensuing description provides exemplary definitions of terms used throughout the applications. It should be noted that terms are described just to explain the embodiments and not limit the invention.

In this application, a resource is an entity that can provide financial protection or reimbursement to individuals and organizations against losses from specific risks or contingencies. An example of a resource may include an insurance company or a payer. From here on, the terms “resource,” “payer,” and “insurance provider” are used interchangeably. The resource information may include the name, location, and/or the encrypted identifier of the resources being used across the one or more tenancies. The services of the resource may include handling the processes for claims submission, preauthorization requirements, and providing the network of approved healthcare providers.

Furthermore, a server endpoint is an entity (such as, a clearinghouse) that can serve as an intermediary between healthcare providers and insurance payers, ensuring an accurate and seamless processing of medical claims. The clearing house may check claims for errors, standardize data formats, and forward them to the appropriate payer for payment. This process may reduce administrative burdens, minimize claim rejections, and accelerate reimbursements. For example, a clearing house may receive a claim from a hospital, validate it against payer-specific requirements, and then submit it to the insurance company for reimbursement. Prominent examples of healthcare clearing houses include Office Ally® and Change Healthcare®. The service plans of the server endpoint may include claims submission and validation, eligibility verification, claims tracking, denial management, transaction fee, server exchange costs, electronic remittance advice, etc. These features help in reducing administrative burdens, minimizing claim rejections, and accelerating reimbursements.

Additionally, a meta database is a centralized database that stores the policies and the resource IDs in a standardized manner. Each resource is defined with a specific API in the meta database. In this application, the meta database is defined as the “payer directory (PD)” or “PD database.” A request of a user may include insurance claims, a request for adjusting billing details, connecting with a payer, overriding a payer, etc. In this application, the organization may refer to an entity that provides healthcare services, i.e., a hospital, clinic, medical laboratory, etc. In this application, terms such as “provider” or “organization” refer to a hospital.

A node can be authenticated employees of an enterprise or engineers, lawyers, scientists, laborers, artisans, or artists within or outside the enterprise. The node can also include authenticated users of the organization, i.e., a hospital etc. From here on, the terms “node” and “authenticated user” are used interchangeably in this application. The enterprise can be an entity that provides cloud services and manages applications of the organization to connect with the server endpoints and resources. The enterprise can have multiple tenancies on its private cloud network and may extend its services to other enterprises. One example of such enterprise can be Oracle™.

In some embodiments, techniques may be provided for creating a data ingestion layer to store and map data. Creating the data ingestion layer may include mapping a payer ID to a clearing house in the PD database, parsing the data to detect duplicate payers, and then validating the data. Creating the data ingestion layer may further include defining application programming interfaces (APIs) for the payers, registering errors, and updating the APIs. The one or more errors may be registered as follow up actions for a user. The techniques may further reroute the claims of a user from a first clearing house to a second clearing house by receiving the claim request from the user, authenticating the request at an API gateway, retrieving an API of a payer associated with the claims, and retrieving mapping and policies associated with the claims from the PD database.

In another aspect, the PD database can be a directory that handles automated financial transaction processing at the cloud network. The techniques may further involve rerouting the claims based on the mapping and one or more policies and returning a response to the clearing house. The response may include exchanging the credentials or financial data of the payer and/or the user with the clearing house.

The claim processing may be automated using a machine learning engine. The one or more payers and their services may be displayed on a user interface. The user interface may allow users to choose from different clearing houses, payers within or outside of the cloud network, and their respective services. The services offered by the payers may include providing claims submission, preauthorization requirements, and the network of approved healthcare providers. In one instance, the user interface may allow the clearing house to choose from the one or more payers working with the hospital, and the one or more service plans of the clearing house. The service plans of the clearing house may include handling pricing of offered services and tax handling, amongst other things.

In yet another aspect, the techniques mentioned in the disclosure may consolidate multiple APIs and payers’ data across a nation, in the centralized directory or the meta database. Parsing data and detecting duplicate payers (i.e., payers registered across one or more clearing houses under same name or ID) can be done using algorithms like prefix-based search, fuzzy matching, and full string matching. In certain instances, a node (i.e., authorized personnel) and/or the payer can manage its services by assessing the APIs stored in the PD database and by using one or more policies. The one or more policies may define a scope of the payer or an authenticated user of the enterprise. The one or more policies may also dictate which payers can work with the organization and vice versa. In another instance, the machine learning engine may process the claims and optimize the services plans based on user preferences. The machine learning engine can make informed decisions by using the one or more policies, one or more confidence metrics, and users’ feedback stored in a historical database.

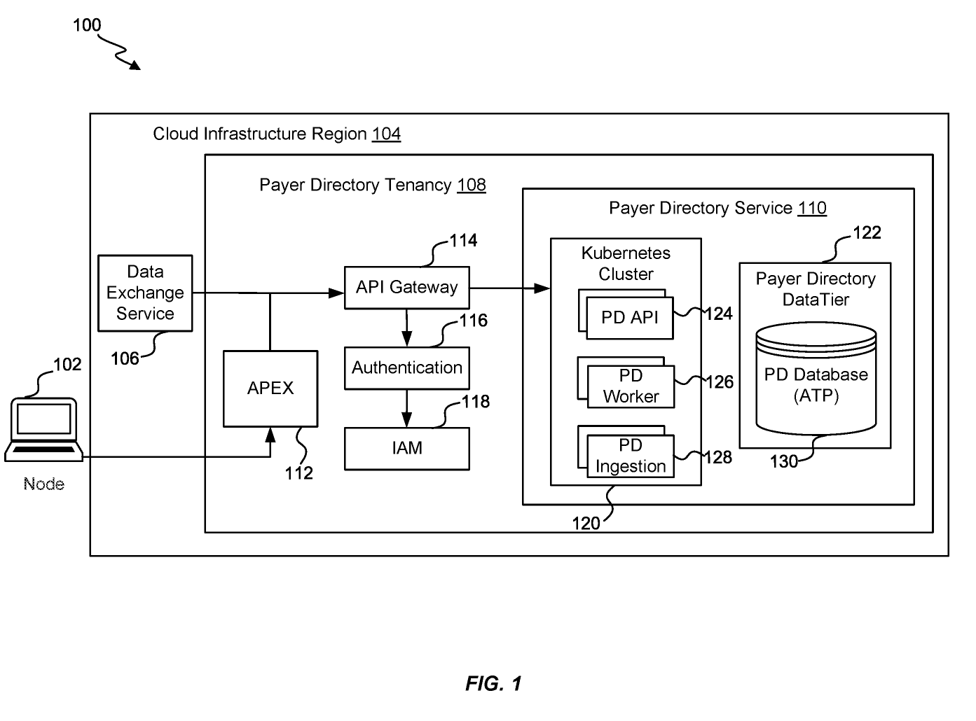

FIG. 1 illustrates a resource identification system 100 hosted in a cloud network, in accordance with some aspects of the present disclosure. The resource identification system 100, that is centralized, may include a node 102 of an enterprise, accessing a cloud infrastructure region 104 of the enterprise or a third party. The cloud infrastructure region 104 is a distinct geographical area where a cloud service provider (CSP) can operate multiple data centers. These regions are designed to offer high availability, fault tolerance, and low latency for various cloud services. A region may contain multiple isolated data centers, known as availability zones (AZs), which are physically separated to ensure that failure in one does not affect the others. This setup allows organizations to deploy applications and data across different AZs within the same region, enhancing reliability and performance of their applications.

The cloud infrastructure region 104 includes a data exchange service 106 and a payer directory tenancy 108. The data exchange service 106 provides seamless data exchange between different tenants working in the cloud infrastructure region 104 of the enterprise. In one example, the data exchange service 106 may include unifying the financial services of the organization around a common, interoperable, and royalty-free technical standard for secure and convenient access to business financial data. The data exchange service 106 may work with different financial institutions, fintech companies, and data aggregators to ensure that data is exchanged in a secure and standardized manner. The payer directory tenancy 108 may be a separate tenancy of the cloud network, amongst other tenancies. The payer directory tenancy 108 may be influenced by the location, policies, applications, and services provided by different tenants at the cloud network. The payer directory tenancy 108 may include an application express (APEX 112), an API gateway 114, an authentication block 116, an identity and access management (IAM) block 118, and a payer directory service 110.

The APEX 112 is communicatively coupled with the node 102 and the data exchange service 106. The APEX 112 may be a development platform that enables rapid application development with minimal coding, using a visual interface and drag-and-drop components. The APEX 112 can provide robust tools for data visualization, reporting, and interactive grids, allowing users to easily manipulate and display data. Examples of the APEX 112 may include APEX Oracle™, Mendix, OutSystems, Appian, etc. The data exchange services 106 and the nodes 102 interact with the APEX 112 to access the payer directory service 110. To access the payer directory service 110, the node 102 may go through several screening and authentication stages. The API gateway 114 acts as a single-entry point for all user requests to the payer directory service 110. The request of the user may include directory information request, API visibility request, insurance claims, 284N/notice of admission files, etc. The API gateway 114 can simplify the process of creating, publishing, maintaining, monitoring, and securing APIs by generalizing the underlying infrastructure and logic. The API gateway 114 may have an endpoint, that has the APIs exposed to the authenticated users for directory management and rerouting. The API gateways 114 may handle various tasks such as request routing, composition, and protocol translation, ensuring that user requests are efficiently directed to the payer directory service 110. For this purpose, the API gateway 114 forwards the request to the authentication block 116. The authentication block 116 may handle user/node validation, authorization, request validation, rate limiting, and traffic management, which may enhance the security and performance of APIs. If the authentication block 116 gets a request from an unauthorized or anomalous entity, the request is sent to the IAM block 118. The IAM block 118 may contain a framework of policies and technologies that ensure the right individuals have appropriate access to technology resources. The IAM block 118 may use OAuth2 access token to achieve authorization in the cloud network. Hence, increasing the security of the centralized payer identification system and making it a reliable storage medium.

The payer directory service 110 may include a Kubernetes cluster 120 and a payer directory data tier 122. The Kubernetes cluster 120 may allow the enterprise to run containerized applications using Kubernetes tool i.e., Shepherd etc. Examples of the Kubernetes cluster 120 may include Oracle™ Kubernetes engine (OKE), Redis master, etc. The Kubernetes cluster 120 may include a payer director (PD) API 124, a PD worker 126, and a PD ingestion block 128. The PD API 124 may serve as the primary interface for external applications and services to interact with the payer directory. The PD API may handle incoming requests, such as queries for payer information, updates to the directory, and other administrative tasks.

The PD worker 126 is responsible for executing background tasks and processing jobs that are offloaded from the main API. These tasks might include data validation, transformation, and enrichment, ensuring that the information in the payer directory is accurate and up to date. The PD worker 126 operates asynchronously, allowing the system to handle large volumes of data and complex operations without impacting the performance of the APIs. By distributing the workload, the PD worker 126 may help maintain the efficiency and responsiveness of the payer directory service 110.

The PD ingestion block 128 can handle the ingestion of new data into the payer directory. The PD ingestion block 128 may process incoming data feeds from various sources, such as insurance companies, healthcare providers, data exchange services, financial partners, and other relevant entities. Tasks like data parsing, normalization, and integration, can be managed by the PD ingestion block 128, ensuring that the new data is correctly formatted and consistent with the existing records in the meta database.

The Payer directory data tier 122 is a data storage medium that includes a PD database 130 or the meta database. The PD database 130 is a centralized database that keeps nation-wide records of all payer’s information and their mappings with the server endpoints. The PD database 130 hosts the data that is represented across multiple databases in one region and can have a backup directory in some other location too. For example, the PD database 130 of the enterprise will be in the Ashburn region with a failover in the Chicago region. The PD database 130 stores payer information in a standardized format where individual payers get a unique API assigned to it. The PD database 130 can also help in managing autonomous transaction processing (ATP) at the cloud network. A backup managed by the enterprise itself can be used to recover to a past point of time in case of unexpended logical data corruption. The data plane could be replicated in any available region using standard deployment tools, i.e., Shepherd, etc. The PD database 130 may be registered with data safe to log audit events in a data safe repository and will be made available to the cloud logging system. For disaster recovery, the repository restoration process may include restoring guard database in a secondary region and using Shepherd to deploy infrastructure in a secondary region.

Standard integrated logging (both access level and execution logs) can be enabled at the load balancer (not shown), the API gateway 114, and the PD database 130. Application logs can be monitored from the load balancer, the API gateway 114, and the PD database 130 and the corresponding metrices are calculated. Similarly, confidence metrices for the resource and the server endpoints are also calculated. The confidence metrices range from 0-100, where a lower metric value represents a higher risk/instability associated with the resource and/or the server endpoint and vice versa. In case of anomalous behavior, exception logs will result in metrics being published in the cloud network. The resource identification system 100 may also allow the authenticated users to access the APIs through a user interface (UI) that is consolidated. The authenticated users may include internal data exchange Ops users, hospital fiscal management staff, DevOps query user, DevOps admin user, HDX system, support teams, etc. Activities of these persons may include use of payer demographic data, analysis of payer requirements and details, enrollment of payers and providers, and mapping payer requirements with read/write access to the PD database 130. The resource identification system 100 may also provide automated re-routing and self-service to clients using machine learning techniques, ensuring fast processing of user request. A payer directory team may be responsible for provisioning and maintaining data plane resources and will own the services release pipeline.

In one instance, the payer directory service 110 may retrieve credentials for the ATP connection from a vault during a start-up phase. The user may send an HTTPS request with an XML content and associated authentication details in the header. The request comes to the API gateway 114, and the API gateway 114 uses the authentication block 116 for authentication and authorization. Authentication will be done via the IAM block 118. The request is forwarded to the payer directory service 110. The payer directory service 110 then may retrieve the data from the PD database 130. The payer directory service 110 can process the request and return the response.

In another instance, the PD database 130 may store the payer information of all the payers associated with a hospital. The hospital may be working with a set of server endpoints, i.e., clearing houses. The resource identification system 100 will collect information about the clearing houses and may get different identifiers for the same payers at different clearing houses. The resource identification system 100 may define a unique API to assess a payer. The PD database 130 may store an ID associated with the API of the payer. Hence, all payers can be stored in the PD database 130 in a standardized way where no two payers will have the same payerID. Consequently, reducing the manual labor of finding many different IDs that belong to the same payer across a region.

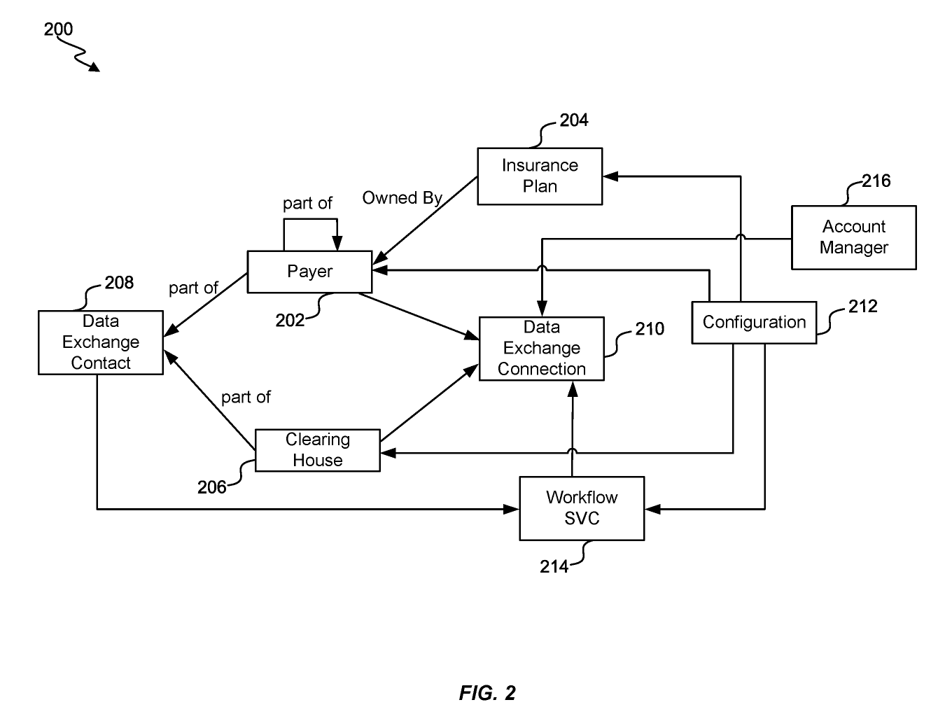

FIG. 2 illustrates a data model 200 to reroute requests of a user, in accordance with some aspects of the present disclosure. The data model 200 is based on the fast healthcare interoperability resources (FHIR) model, that is designed to enable information exchange to support the provision of healthcare in a wide variety of settings. Publication of data through a standard FHIR-based API will enable third parties to develop applications through which consumers and providers can query the participants in a payer’s network that may provide services that address their health care needs. The data model 200 may include a payer 202, an insurance plan 204, a clearing house 206, a data exchange contact 208, a data exchange connection 210, a configuration block 212, a workflow service class (SVC 214), and an account manager 216. The payer 202 is the entity that covers the insurance, and the insurance plan 204 is owned by the payer 202. The insurance plan 204 may contain information related to all the health plans. The clearing house 206 may hold the information of all the clearing houses that enable the exchange of healthcare data between a payer and provider (or its organization).

The data exchange contact 208 may be a customer service representative for either the payer 202 or the clearing house 206. The data exchange connection 210 may represent the link to the payer 202 from the clearing house 206. The data exchange connection 210 works based on different parameters (i.e., cost of a payer connection, reliability/confidence metric of the connection, etc.). The configuration block 212 may provide overriding data for a combination of payer, health plan, clearing house and workflow service. The workflow SVC 214 may provide all the workflows that are supported by the data exchange service 106. The account manager 216 handles the accounts that represent the data exchange connection 210. The data model 200 may use FHIR terminologies to define APIs for different payers. The implementation layer can work with multiple tables internally to return the payer information. This may help in consolidating all the on-premises segregated databases and spreadsheet into one data model. All the dates may be stored in the UTC format. Every entity will have canonical fields to provide a consistent history.

In one instance, the data model 200 may allow the resource identification system 100 to act as a switch for rerouting the requests of the user. The user may send a request that calls services of a resource, say ‘payerxx.’ Suppose the payerxx is registered in the PD database 130 with the payerID: 6789. The resource identification system 100 will retrieve the API associated with the payerxx and route the request towards payerID:6789. Now in case the payerxx gets shut down for some reason, instead of manually recovering the requests made to payerxx, the resource identification system 100 may do autonomous rerouting of user’s request. The authenticated user can access the API of payerxx from the PD database 130, that will return payerID of a compromised resource, i.e., payerxx. The authenticated user can switch the APIs of resources and can reroute the incoming traffic to a different resource, say payeryy, using its corresponding API. In this way, the PD database 130 makes the payer identification easier and makes the essential routing information centrally available via self-service and APIs, so that re-routing of claims and eligibility transactions can be automated to other clearinghouses to respond to any partner outage.

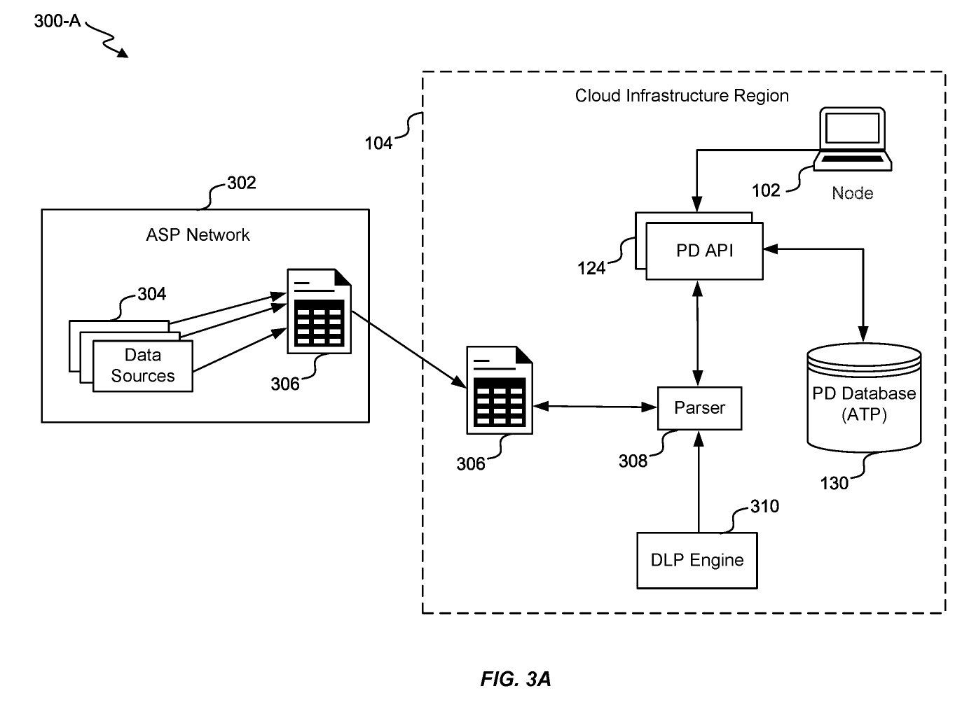

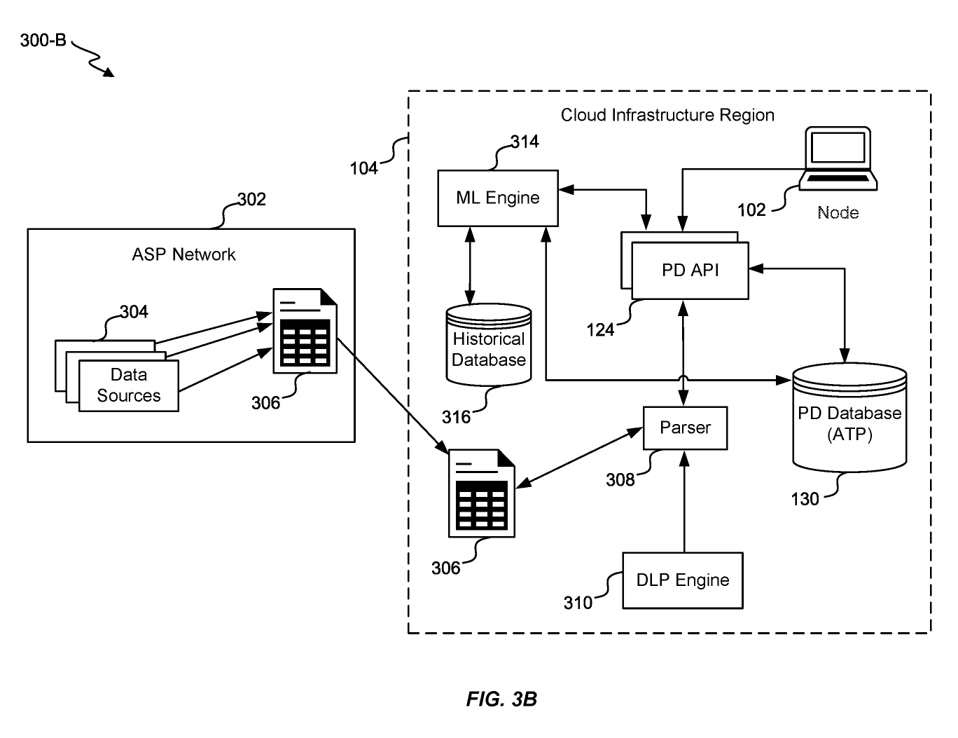

FIG. 3A illustrates a data flow 300-A between an application service provider (ASP) network 302 and the cloud infrastructure region 104, in accordance with some aspects of the present disclosure. The data flow 300-A allows the data to be manually moved from the ASP network 302 into the cloud infrastructure region 104, as CSV. The ASP network 302 may provide software applications and related services over the internet. An example of ASP network 302 may include the Cerner ASP network, which is a major supplier of health information technology (HIT) solutions, services, devices, and hardware. The ASP network 302 may include data sources 304 and a CSV file 306 that may include a log of user requests. The data sources 304 may include SQL server, databases, data objects from SharePoint, Microsoft Access, etc. A user at the ASP network 302 converts these data sources into the CSV file 306. The relative size of these individual data sources is small enough to be carried within the CSV file 306.

At the cloud infrastructure region 104, a generalized data ingestion layer is created that can load the CSV file 306. The data ingestion layer provides a reliable and reusable model that may import data from the CSV file 306 into a target data storage (the PD database 130) or processing platform. The data ingestion layer will be idempotent. The ingestion of the same data repeatedly leaves the resource identification system 100 in a consistent state. The components at the cloud infrastructure region 104 may include a load processor (not shown), a parser 308, a data loss prevention (DLP) engine 310, the PD API 124, the PD database 130, and the node 102. The data ingestion layer may involve identifying the data sources 304 of the CSV files. These could be local files, cloud storage, or external data providers. The resource ID may be mapped to a server endpoint in the PD database 130 (or the meta database), at runtime, using different mapping algorithms. The source-destination mapper can take a relationship mapping from a source value to the data model 200. This may help in saving time as the system operator no longer needs to manually map different payers to relative clearinghouses that are working with the hospital.

The parser 308 may analyze the data and detect any duplicate resources within the data, i.e., two or more payers registered under the same payer ID and/or a payer registered more than once in the CSV file 306. The duplication can be supported based on different algorithms that can be implemented in the parser 308. Examples of such algorithms may include prefix-based search, fuzzy matching, or full string matching, etc. Prefix-based search can match strings that start with a given prefix and can narrow down results based on the initial characters. Fuzzy matching methods may find strings that are equal, accounting for minor differences like typos. Algorithms like Levenshtein distance may be used to measure similarity. The full string-matching technique may search for exact matches of a pattern within a text. Algorithms like Knuth-Morris-Pratt (KMP) and Boyer-Moore are commonly used for full string matching.

The DLP engine 310 may provide data monitoring, logging, and metric calculations. The DLP engine 310 may also provide basic validation (names, addresses and more). All the failures will be registered in the system as follow-up actions for the users. The DLP engine 310 may include a score calculator that can determine confidence metrices for the payers and the clearing houses working with the hospitals. The confidence metrices may indicate the reliability, optimum pricing/rates, and quality of the payers and the clearinghouses. The payers or clearing houses with confidence metrices below a threshold may get a warning or may be limited/blocked from using numerous services of the enterprise. When calculating the confidence metric, every single data flow needs to have a definitive exit point, regardless of the associated error or exception. The confidence matrices may be published on the cloud network and are also displayed on the UI. The calculation of the confidence metric may depend on a total turn around metric (avg, min, max - per monitoring interval), throughput per monitoring interval, or an error rate per monitoring interval, etc.

The DLP engine 310 may use cloud monitoring services to collect application performance custom metrics and confidence metrics. For this purpose, the DLP engine 310 may build a log search to facilitate troubleshooting for the payer directory applications. The DLP engine 310 may also build a dashboard to observe current services confidence metrics and error log patterns. The DLP engine 310 can set up a notification service so when the confidence metrics are below or error log is above a threshold, then the notification service can alarm the cloud applications. The DLP engine 310 may also have a logging analytics service that may be chained to utilize the notification service. Logging will be done for all tenancies of the cloud network, and the logging may have four categories: application logs, system logs, custom logs, and telemetry and matrix logs. The application logs can include error conditions, application anomalous conditions, and conditions considered important/useful for monitoring performance of the application. The system logs can include information on the system’s health, availability of resources, and anomalous behaviors to mention a few. Information from system logs will be consumed into logging analytics service of the DLP engine 310. The custom logs may be a catch-all for any logging requirements not covered within Application or System logging and can include things like custom application, 3^{rd} party software logging, etc. the telemetry and matrix logs can provide information such as daily consumption of resources, application-specific response and processing metrics, latency metrics, etc. In one embodiment, separate databases may be employed within the cloud infrastructure region 104 to store all these logs.

The DLP engine 310 can validate the data of the CSV file 306 with the data stored in the PD database 310/ meta database. The DLP engine 310 may also register all the errors found in the database as follow-up actions for the users. The APIs may be defined for the resources (i.e., payers at the API gateway 114). The PD API 124 may serve as the primary interface for external applications and services to interact with the payer directory. The PD API 124 may handle incoming requests, such as queries for payer information, updates to the directory, and other administrative tasks. The authenticated user at the node 102 may access the API of a particular resource from the PD API 124. The APIs of all the registered nodes may be stored and updated in the PD database 130. The PD database 130 may store the policies of the enterprise, payer, clearinghouse, or the hospital. For example, the hospital may have the policy of working only with those clearinghouses that are registered with their partner enterprises. This means that user requests can only be rerouted to any of the registered clearing houses. The policies and mapping between the payers and the clearinghouses may influence the rerouting of the requests.

The authenticated user at the node 102 may call logs of payer IDs and APIs from the PD database 130 and reroute the user requests using the PD API 124. Based on the policies and mappings retrieved from the PD database 130, the request may be rerouted to other clearinghouses and a response may be generated. The response to the request may be displayed at the user interface for customer’s visibility. The resource (payer) may manage its services (health plans etc.) by modifying the policies or their APIs.

FIG. 3B illustrates an automated data flow 300-B between the ASP network 302 and the cloud infrastructure region 104, in accordance with some aspects of the present disclosure. The automated data flow 300-B may allow the enterprise to offer fully automated request processing or a self-service option on the user interface. This may help in reducing time constraints, manual labor, and data management costs at the enterprise level. The cloud infrastructure region 104 may host a machine learning (ML) engine 314 and a historical database 316, among other things, to build a context. This context may help the payer identification system 100 to make intelligent and informed decisions.

The ML engine 314 may analyze the incoming claim data using natural language processing (NLP) and other AI techniques to extract relevant information such as a claim’s type, policy details, and claimant information. The extracted data may then be processed to identify patterns and determine the most appropriate payer based on predefined rules and historical data. The historical data is based on a user’s feedback from previous requests and may be stored in the historical database 316. For example, in the healthcare sector, the ML engine 314 can retrieve the API of the payer to which the claim request is directed to and can automatically route claims to the correct insurance provider by matching the claim details with the provider's policies and coverage criteria. The ML engine 314 can also analyze the request and match the payer ID with the request based on the content of the request. This reduces the need for manual intervention, speeds up the claims process, and minimizes errors. The ML engine 314 may process the request and optimize the service plans of the resources according to user preferences. The ML engine 314 can do so by using the policies corresponding to the request, the confidence metrics of the resource and the server endpoint, and the user feedback stored in the historical database 316.

The ML engine 314 can also prioritize claims based on urgency or complexity, ensuring that high-priority claims are addressed promptly. Additionally, the ML engine 314 may continuously learn from new data, improving its accuracy and efficiency over time. The ML engine 314 can handle large volumes of claims, making it scalable for organizations of any size. By automating the routing process, payers can reduce operational costs, enhance customers’ satisfaction, and ensure timely settlements of claims. The user interface may allow the users to automate their proceedings and provide recommendations and best-practices, using the ML engine 314. Hence, the resource identification system 100 may not only provide claim rerouting through switching APIs but also cost optimization and self-service to its customers.

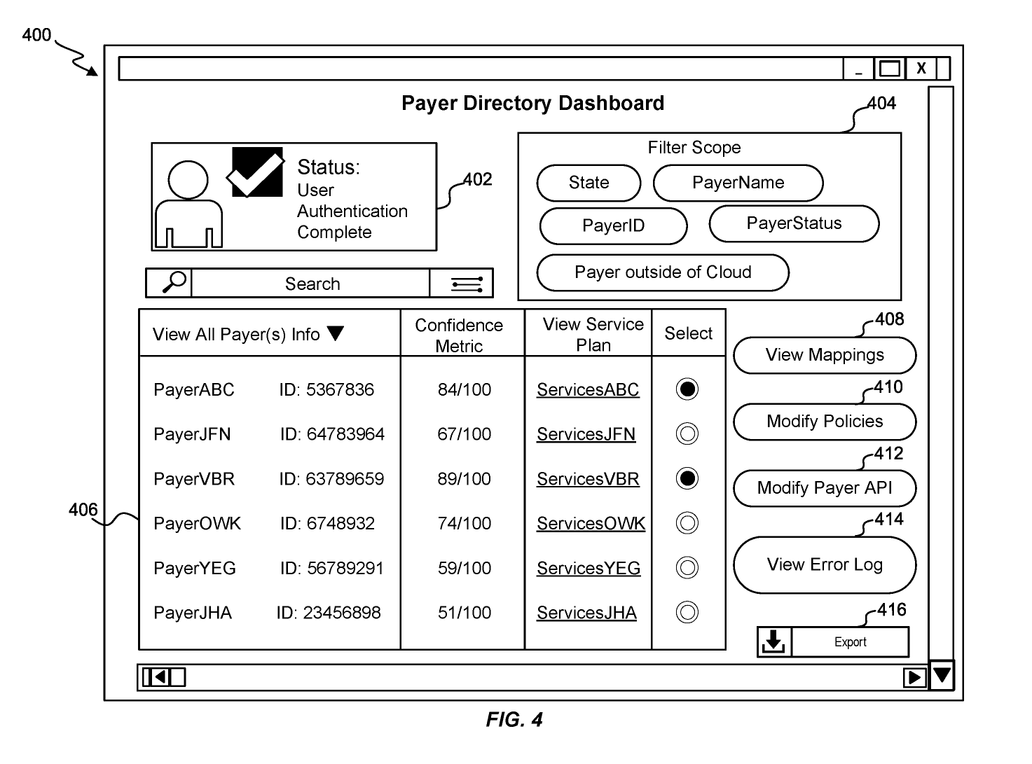

FIG. 4 illustrates a user interface (UI) 400 for authenticated users at the node 102, showing a resource directory dashboard, in accordance with some aspects of the present disclosure. The authenticated users may include internal data exchange Ops users, hospital fiscal management staff, DevOps query user, DevOps admin user, HDX system, support teams, etc. Activities of these people may include using payer’s demographic data, analysis of payer’s requirements, enrollment of payers and providers, and mapping payer requirements with a read/write access to the PD database 130. The resource directory dashboard, shown as a payer directory dashboard on the UI 400, allows the authenticated users to access the APIs of payers and reroute the requests from a first server endpoint to a second server endpoint in case of service outages etc.

A status bar 402 may indicate the authentication stages of the accessing entity. The accessing entity can enter the backend system by entering its work email address or authorized token provided by the cloud service. The filter section 404 may narrow down the list of payers by providing filters such as, the name of a state, payer name, payer ID, payer status i.e., working, suspended, registered, etc., payer outside of the cloud network, etc. Each of these filters refine the list of payers present in the PD database 130 and can save time and effort. A list of payers 406 may retrieve data from the PD database 130 and provide the authenticated users with all required payers, their payer IDs, and corresponding confidence metrics. The list of payers 406 may further allow the authenticated users to view the service plans of different payers and select one or more payers they want to manage or connect with. This means that the server endpoint or a user from the clearing house can also choose from or select the payers it wants to work with and can view their service plans.

The UI 400 may also provide a view of mappings 408 between the payers and the clearing houses associated with the hospital and a view of error log 414 that may indicate the issues encountered when assembling the PD database 130 or actions that may need a follow up. The UI 400 may also provide the option to the authenticated users to modify policies 410 and modify payer API 412. The access to modify payer API or policies may depend on the scope of the authenticated user. The UI 400 further can allow the authenticated user to export 416 error logs, policies, mappings, and/or payers list with other entities residing inside the cloud network. The data can be exchanged between different APIs i.e., API to API data exchange (not shown in the UI 400), with just selecting two different APIs of two different payers and allowing the data exchange.

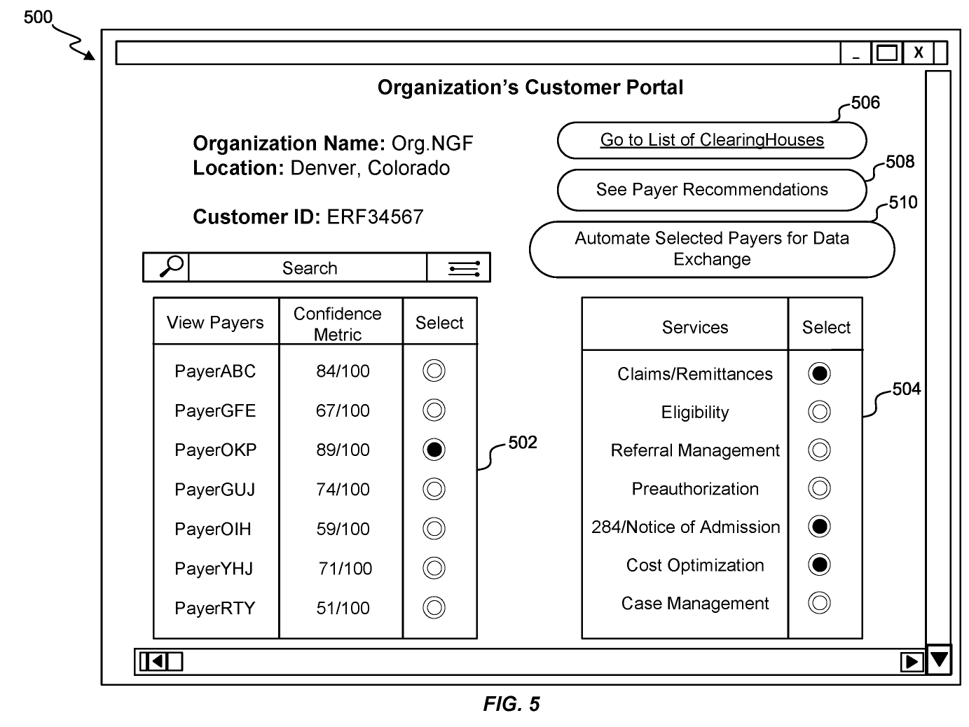

FIG. 5 illustrates a UI of the organization, showing a customer portal 500, in accordance with some aspects of the present disclosure. The customer portal 500 may illustrate another aspect of the UI 400 and the customer portal may be used by the staff of the organization, i.e., the hospital’s finance department, or the users registered at the organization’s systems. The customer portal 500 may display a payers’ list 502 that may include the name of payers and their corresponding confidence metrics. The user may select from the payers’ list 502 and direct their request to the selected payer. Ther user may also select from a list of services 504 of a payer (i.e., claims/remittances, eligibility, referral management, preauthorization, 284/notice of admission, cost optimization, case management, etc.). This means the users can select from different server endpoints, resources that are associated with the cloud network or are outside of the cloud network, and their corresponding services.

The user can further go to a list of clearinghouses 506, can see payer recommendations 508, and can automate selected payers for a data exchange 510. The automation may lead to processing the user request without any assistance from the user (i.e., the ML engine 314 can fill in any information required to handle the case). The recommendations may be provided to route the request through reliable sources, or to manage pricing/expenses, based on policies and users’ feedback.

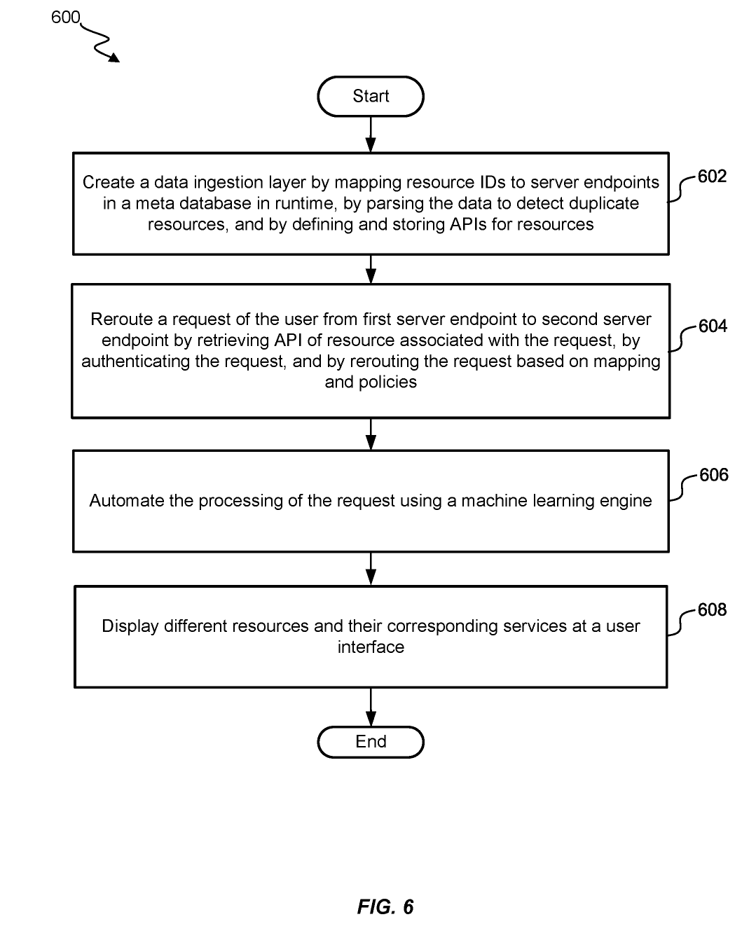

FIG. 6 illustrates an exemplary workflow 600 for identifying resources and rerouting requests of users to different resources, in accordance with some aspects of the present disclosure. The blocks in the exemplary workflow 600 are illustrated in a specific order, while the order can be modified, for example, some blocks may be performed before others, and some blocks may be performed simultaneously. The blocks can be performed by hardware, software, or a combination thereof. The process may begin, at block 602, by creating a data ingestion layer to store and map data in the PD database 130. The creation of data ingestion layer may include mapping a resource ID to a server endpoint in the meta database or the PD database 130 and parsing the data and detecting any duplicate resources in the data, and validating the data stored in the meta database. This may further include defining APIs for resources at the API gateway 114, registering errors as follow up actions for a user, and storing and updating the API in the PD database 130.

At block 604, the request of a user (claims, remittance, case management, etc.) may be rerouted from a first server endpoint to a second server endpoint, i.e., from clearinghouseA to clearinghouseB. The rerouting of request may include receiving request from the user, authenticating the request at the API gateway, and retrieving an API of a resource associated with a request from the PD database 130. The rerouting of request may further include retrieving mapping and policies associated with the request from the PD database 130 and based on these mappings and policies, rerouting the request and returning a response to the server endpoint. The response may include the credentials, payers’ information, etc.

At block 606, the request processing may be automated using the ML engine 314. The ML engine 314 may automate the request handling by providing self-service at the UI 400. The ML engine 314 may process the request and optimize the services according to a user’s preferences by using: the policies corresponding to the request, the confidence metrices associated with the server endpoints and resources, and feedback of the user stored in the historical database 316.

Finally at block 608, a list of resources (the payer’s list 502) and their corresponding services are displayed on the user interface (customer portal 500) for the user to choose from. The customer portal 500 may display a payers’ list 502 that may include the names of payers and their corresponding confidence metrics. The users may select a payer from the payers’ list 502 and direct their request to the selected payer. Ther users may also select from a list of services 504 of a payer (i.e., claims/remittances, eligibility, referral management, preauthorization, 284/notice of admission, cost optimization, case management, etc.). This provides self-service to the users, which is an important aspect of the present disclosure.

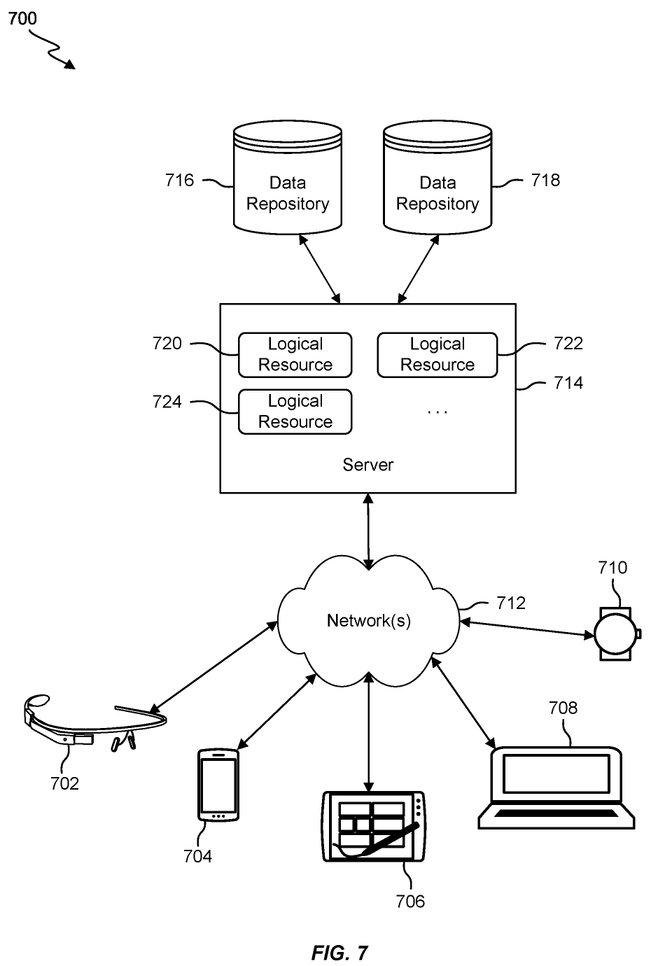

FIG. 7 depicts a simplified diagram of a distributed system 700 for implementing an embodiment. In the illustrated embodiment, distributed system 700 includes one or more client computing devices 702, 704, 706, 708, 710, coupled to a server 714 via one or more communication networks. The client computing devices 702, 704, 706, 708, 710, may be configured to execute one or more applications. In various aspects, server 714 may be adapted to run one or more services or software applications that enable techniques for the secure communication network. In certain aspects, server 714 may also provide other services or software applications that can include non-virtual and virtual environments. In some aspects, these services may be offered as web-based or cloud services, such as under a Software as a Service (SaaS) model to the users of client computing devices 702, 704, 706, 708, 710. Users operating the client computing devices 702, 704, 706, 708, 710, may in turn utilize one or more client applications to interact with server 714 to utilize the services provided by these components.

In the configuration depicted in FIG. 7, server 714 may include one or more components 720, 722 and 724 that implement the functions performed by server 714. These components may include software components that may be executed by one or more processors, hardware components, or combinations thereof. It should be appreciated that various system configurations are possible, which may be different from distributed system 700. The embodiment shown in FIG. 7 is thus one example of a distributed system for implementing an embodiment system and is not intended to be limiting.

Users may use the client computing devices 702, 704, 706, 708, 710, for techniques in accordance with the teachings of this disclosure. A client device may provide an interface that enables a user of the client device to interact with the client device. The client device may also output information to the user via this interface. Although FIG. 7 depicts only five client computing devices, any number of client computing devices may be supported.

The client devices may include various types of computing systems such as smart phones or other portable handheld devices, general purpose computers such as personal computers and laptops, workstation computers, personal assistant devices, smart watches, smart glasses, or other wearable devices, equipment firmware, gaming systems, thin clients, various messaging devices, sensors or other sensing devices, and the like. These computing devices may run various types and versions of software applications and operating systems (e.g., Microsoft Windows®, Apple Macintosh®, UNIX® or UNIX-like operating systems, Linux® or Linux-like operating systems such as Oracle® Linux and Google Chrome® OS) including various mobile operating systems (e.g., Microsoft Windows Mobile®, iOS®, Windows Phone®, Android®, HarmonyOS®, Tizen®, KaiOS®, Sailfish® OS, Ubuntu® Touch, CalyxOS®). Portable handheld devices may include cellular phones, smartphones, (e.g., an iPhone®), tablets (e.g., iPad®), and the like. Virtual personal assistants such as Amazon® Alexa®, Google® Assistant, Microsoft® Cortana®, Apple® Siri®, and others may be implemented on devices with a microphone and/or camera to receive user or environmental inputs, as well as a speaker and/or display to respond to the inputs.

Wearable devices may include Apple® Watch, Samsung Galaxy® Watch, Meta Quest®, Ray-Ban® Meta® smart glasses, Snap® Spectacles, and other devices. Gaming systems may include various handheld gaming devices, Internet-enabled gaming devices (e.g., a Microsoft Xbox® gaming console with or without a Kinect® gesture input device, Sony PlayStation® system, Nintendo Switch®, and other devices), and the like. The client devices may be capable of executing various applications such as various Internet-related apps, communication applications (e.g., e-mail applications, short message service (SMS) applications) and may use various communication protocols.

Network(s) 612 may be any type of network familiar to those skilled in the art that can support data communications using any of a variety of available protocols, including without limitation TCP/IP (transmission control protocol/Internet protocol), SNA (systems network architecture), IPX (Internet packet exchange), AppleTalk®, and the like. Merely by way of example, network(s) 612 can be a local area network (LAN), networks based on Ethernet, Token-Ring, a wide-area network (WAN), the Internet, a virtual network, a virtual private network (VPN), an intranet, an extranet, a public switched telephone network (PSTN), an infra-red network, a wireless network (e.g., a network operating under any of the Institute of Electrical and Electronics (IEEE) 1002.11 suite of protocols, Bluetooth®, and/or any other wireless protocol), and/or any combination of these and/or other networks.

Server 714 may be composed of one or more general purpose computers, specialized server computers (including, by way of example, PC (personal computer) servers, UNIX® servers, LINIX® servers, mid-range servers, mainframe computers, rack-mounted servers, etc.), server farms, server clusters, a Real Application Cluster (RAC), database servers, or any other appropriate arrangement and/or combination. Server 714 can include one or more virtual machines running virtual operating systems, or other computing architectures involving virtualization such as one or more flexible pools of logical storage devices that can be virtualized to maintain virtual storage devices for the server. In various aspects, server 714 may be adapted to run one or more services or software applications that provide the functionality described in the foregoing disclosure.

The computing systems in server 714 may run one or more operating systems including any of those discussed above, as well as any commercially available server operating system. Server 714 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle®, Microsoft®, SAP®, Amazon®, Sybase®, IBM® (International Business Machines), and the like.

In some implementations, server 714 may include one or more applications to analyze and consolidate data feeds and/or event updates received from users of client computing devices 702, 704, 706, 708, 710. As an example, data feeds and/or event updates may include blog feeds, Threads® feeds, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 714 may also include one or more applications to display the data feeds and/or real-time events via one or more display devices of client computing devices 702, 704, 706, 708, 710.

The distributed system 700 may also include one or more data repositories 716, 718. These data repositories may be used to store data and other information in certain aspects. For example, one or more of the data repositories 716, 718 may be used to store information for techniques disclosed herein. Data repositories 716 and 718 may reside in a variety of locations. For example, a data repository used by server 714 may be local to server 714 or may be remote from server 714 and in communication with server 714 via a network-based or dedicated connection. Data repositories 716 and 718 may be of several types. In certain aspects, a data repository used by server 714 may be a database, for example, a relational database, a container database, an Exadata® storage device, or other data storage and retrieval tools such as databases provided by Oracle Corporation® and other vendors. One or more of these databases may be adapted to enable storage, update, and retrieval of data to and from the database in response to structured query language (SQL)-formatted commands.

In certain aspects, one or more data repositories 716, 718 may also be used by applications to store application data. The data repositories used by applications may be of several types such as, for example, a key-value store repository, an object store repository, or a general storage repository supported by a file system.

In one embodiment, server 714 is part of a cloud-based system environment in which diverse services may be offered as cloud services, for a single tenant or for multiple tenants where data, requests, and other information specific to the tenant are kept private from each tenant. In the cloud-based system environment, multiple servers may communicate with each other to perform the work requested by client devices from the same or multiple tenants. The servers communicate on a cloud-side network that is not accessible to the client devices to perform the requested services and keep tenant data confidential from other tenants.

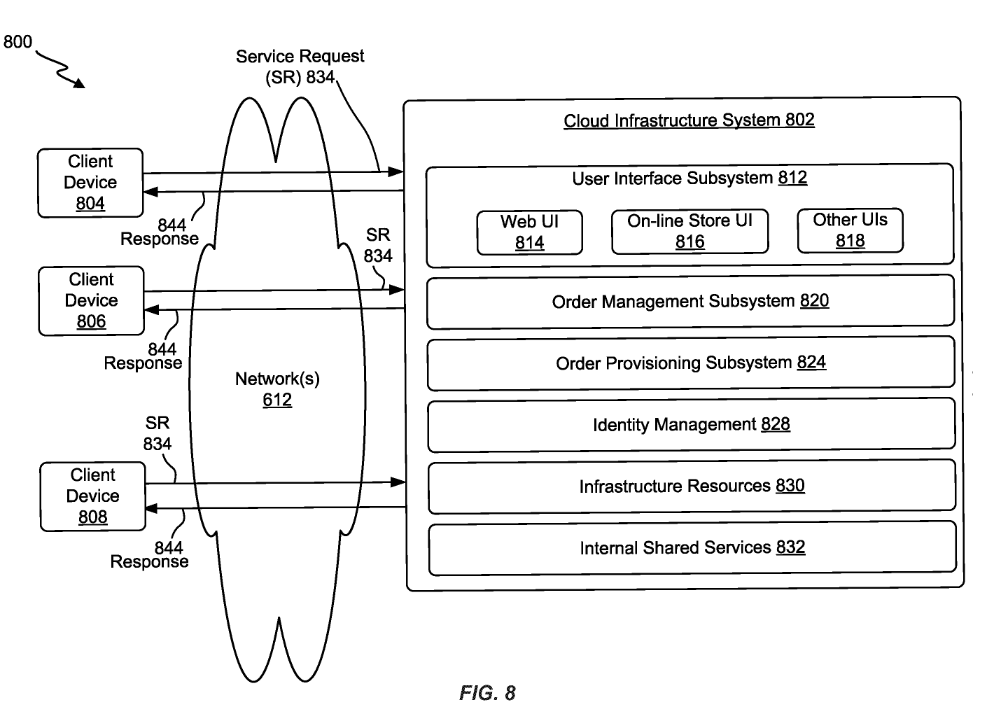

FIG. 8 is a simplified block diagram of a cloud-based system environment 800 in accordance with certain aspects of various embodiments of the invention. In the embodiment depicted in FIG. 8, cloud infrastructure system 802 may provide one or more cloud services that may be requested by users using one or more client devices 804, 806, and 808. Cloud infrastructure system 802 may comprise one or more computers and/or servers that may include those described above for server 714. The computers in cloud infrastructure system 802 may be organized as general-purpose computers, specialized server computers, server farms, server clusters, or any other appropriate arrangement and/or combination.

Network(s) 612 may facilitate communication and exchange of data between the client devices 804, 806, and 808 and cloud infrastructure system 802. Network(s) 612 may include one or more networks. The networks may be of the same or several types. Network(s) 612 may support one or more communication protocols, including wired and/or wireless protocols, for facilitating the communications.

The embodiment depicted in FIG. 8 is only one example of a cloud infrastructure system and is not intended to be limiting. It should be appreciated that, in some other aspects, cloud infrastructure system 802 may have more or fewer components than those depicted in FIG. 8, may combine two or more components, or may have a different configuration or arrangement of components. For example, although FIG. 8 depicts three client devices, any number of client devices may be supported in alternative aspects.

The term cloud service is used to refer to a service that is made available to users on demand and via a communication network such as the Internet by systems (e.g., cloud infrastructure system 802) of a service provider. Typically, in a public cloud environment, servers and systems that make up the cloud service provider's system are different from the cloud customer’s (“tenant’s”) own on-premises servers and systems. The cloud service provider’s systems are managed by the cloud service provider. Tenants can thus avail themselves of cloud services provided by a cloud service provider without having to purchase separate licenses, support, or hardware and software resources for the services. For example, a cloud service provider's system may host an application, and a user may, via the network(s) 612 (e.g., the Internet), on demand, order and use the application without the user having to buy infrastructure resources for executing the application. Cloud services are designed to provide easy, scalable access to applications, resources, and services. Several providers offer cloud services. For example, several cloud services are offered by Oracle Corporation®, such as database services, middleware services, application services, and others.

In certain aspects, cloud infrastructure system 802 may provide one or more cloud services using different models such as a Software as a Service (SaaS) model, a Platform as a Service (PaaS) model, an Infrastructure as a Service (IaaS) model, a Data as a Service (DaaS) model, and others, including hybrid service models. Cloud infrastructure system 802 may include a suite of databases, middleware, applications, and/or other resources that enable provision of the various cloud services.

A SaaS model enables an application or software to be delivered to a tenant’s client device over a communication network like the Internet, as a service, without the tenant having to buy the hardware or software for the underlying application. For example, a SaaS model may be used to provide tenants with access to on-demand applications that are hosted by cloud infrastructure system 802. Examples of SaaS services provided by Oracle Corporation® include, without limitation, diverse services for human resources/capital management, client relationship management (CRM), enterprise resource planning (ERP), supply chain management (SCM), enterprise performance management (EPM), analytics services, social applications, and others.

An IaaS model is used to provide infrastructure resources (e.g., servers, storage, hardware, and networking resources) to a tenant as a cloud service to provide elastic compute and storage capabilities. Various IaaS services are provided by Oracle Corporation®.

A PaaS model is used to provide, as a service, platform and environment resources that enable tenants to develop, run, and manage applications and services without the tenant having to procure, build, or maintain such resources. Examples of PaaS services provided by Oracle Corporation® include, without limitation, Oracle Database Cloud Service (DBCS), Oracle Java Cloud Service (JCS), data management cloud service, various application development solutions services, and others.

A DaaS model is used to provide data as a service. Datasets may be searched, combined, summarized, and downloaded or placed into use between applications. For example, user profile data may be updated by one application and provided to another application. As another example, summaries of user profile information generated based on a dataset may be used to enrich another dataset.

Cloud services are provided on an on-demand self-service basis, subscription-based, elastically scalable, reliable, highly available, and secure manners. For example, a tenant, via a subscription order, may order one or more services provided by cloud infrastructure system 802. Cloud infrastructure system 802 then performs processing to provide the services requested in the tenant's subscription order. Cloud infrastructure system 802 may be configured to provide one or even multiple cloud services.

Cloud infrastructure system 802 may provide the cloud services via different deployment models. In a public cloud model, cloud infrastructure system 802 may be owned by a third-party cloud services provider and the cloud services are offered to any public tenant, where the tenant can be an individual or an enterprise. In certain other aspects, under a private cloud model, cloud infrastructure system 802 may be operated within an organization (e.g., within an enterprise organization) and services provided to clients that are within the organization. For example, the clients may be various departments or employees or other individuals of departments of an enterprise such as the Human Resources department, the payroll department, etc., or other individuals of the enterprise. In certain other aspects, under a community cloud model, the cloud infrastructure system 802 and the services provided may be shared by several organizations in a related community. Various other models such as hybrids of the above-mentioned models may also be used.

Client devices 804, 806, and 808 may be of several types (such as the client computing devices 702, 704, 706, and 708 depicted in FIG. 7) and may be capable of operating one or more client applications. A user may use a client device to interact with cloud infrastructure system 802, such as to request a service provided by cloud infrastructure system 802.

In some aspects, the processing performed by cloud infrastructure system 802 for providing chatbot services may involve big data analysis. This analysis may involve using, analyzing, and manipulating large data sets to detect and visualize various trends, behaviors, relationships, etc. within the data. This analysis may be performed by one or more processors, processing the data in parallel, performing simulations using the data, and the like. For example, big data analysis may be performed by cloud infrastructure system 802 for determining the intent of an utterance. The data used for this analysis may include structured data (e.g., data stored in a database or structured according to a structured model) and/or unstructured data (e.g., data blobs (binary large objects)).

As depicted in the embodiment in FIG. 8, cloud infrastructure system 802 may include infrastructure resources 830 that are utilized for facilitating the provision of various cloud services offered by cloud infrastructure system 802. Infrastructure resources 830 may include, for example, processing resources, storage or memory resources, networking resources, and the like.

In certain aspects, to facilitate efficient provisioning of these resources for supporting the various cloud services provided by cloud infrastructure system 802 for different tenants, the resources may be bundled into sets of resources or resource modules (also referred to as "pods"). Each resource module or pod may comprise a pre-integrated and optimized combination of resources of one or more types. In certain aspects, different pods may be pre-provisioned for several types of cloud services. For example, a first set of pods may be provisioned for a database service, a second set of pods, which may include a different combination of resources than a pod in the first set of pods, may be provisioned for Java service, and the like. For some services, the resources allocated for provisioning the services may be shared between the services.

Cloud infrastructure system 802 may internally use services 832 that are shared by different components of cloud infrastructure system 802 and which facilitate the provisioning of services by cloud infrastructure system 802. These internal shared services may include, without limitation, a security and identity service, an integration service, an enterprise repository service, an enterprise manager service, a virus scanning and whitelist service, a high availability, backup and recovery service, service for enabling cloud support, an email service, a notification service, a file transfer service, and the like.

Cloud infrastructure system 802 may comprise multiple subsystems. These subsystems may be implemented in software, or hardware, or combinations thereof. As depicted in FIG. 8, the subsystems may include a user interface subsystem 812 that enables users of cloud infrastructure system 802 to interact with cloud infrastructure system 802. User interface subsystem 812 may include various interfaces such as a web UI 814, an online store UI 816 where cloud services provided by the cloud infrastructure system 802 are advertised and are purchasable by a consumer, and other UIs 818. For example, a tenant may, using a client device, request (service request 834) one or more services provided by cloud infrastructure system 802 using one or more interfaces 814, 816, and 818. For example, a tenant may access the online store, browse cloud services offered by cloud infrastructure system 802, and place a subscription order for one or more services offered by cloud infrastructure system 802 that the tenant wishes to subscribe to. The service request may include information identifying the tenant and one or more services that the tenant desires to subscribe to. For example, a tenant may place a subscription order for a chatbot related service offered by cloud infrastructure system 802. As part of the order, the client may provide information identifying the input (e.g., utterances).

In certain aspects, such as the embodiment depicted in FIG. 8, cloud infrastructure system 802 may comprise an order management subsystem (OMS) 820 that is configured to process the new order. As part of this processing, the OMS 820 may be configured to: create an account for the tenant, if not done already; receive billing and/or accounting information from the tenant that is to be used for billing the tenant for providing the requested service to the tenant; verify the tenant information; upon verification, book the order for the tenant; and orchestrate various workflows to prepare the order for provisioning.

Once properly validated, OMS 820 may then invoke the order provisioning subsystem (OPS) 824 that is configured to provide resources for the order including processing, memory, and networking resources. The provisioning may include allocating resources for the order and configuring the resources to facilitate the service requested by the tenant order. The way resources are provisioned for an order and the type of the provisioned resources may depend upon the type of cloud service that has been ordered by the tenant. For example, according to one workflow, OPS 824 may be configured to determine the cloud service being requested and identify several pods that may have been pre-configured for that cloud service. The number of pods that are allocated for an order may depend upon the size/amount/level/scope of the requested service. For example, the number of pods to be allocated may be determined based upon the number of users to be supported by the service, the duration of time for which the service is being requested, and the like. The allocated pods may then be customized for the requested tenant to provide the requested service.

Cloud infrastructure system 802 may send a response or notification 844 to the tenant to indicate when the requested service is now ready for use. In some instances, information (e.g., a link) may be sent to the tenant that enables the tenant to start using the benefits of the services requested.

Cloud infrastructure system 802 may provide services to multiple tenants. For each tenant, cloud infrastructure system 802 is responsible for managing information related to one or more subscription orders received from the tenant, maintaining tenant data related to the orders, and providing the requested services to the tenant or clients of the tenant. Cloud infrastructure system 802 may also collect usage statistics regarding a tenant's use of subscribed services. For example, statistics may be collected for storage used, the amount of data transferred, the number of users, and the amount of system up time and system down time, and the like. This usage information may be used to bill the tenant. Billing may be done, for example, on a monthly cycle.

Cloud infrastructure system 802 may provide services to multiple tenants in parallel. Cloud infrastructure system 802 may store information for these tenants, including proprietary information. In certain aspects, cloud infrastructure system 802 comprises an identity management subsystem (IMS) 828 that is configured to manage tenant’s information and provide the separation of the managed information such that information related to one tenant is not accessible by another tenant. IMS 828 may be configured to provide various security-related services such as identity services, such as information access management, authentication and authorization services, services for managing tenant identities and roles and related capabilities, and the like.

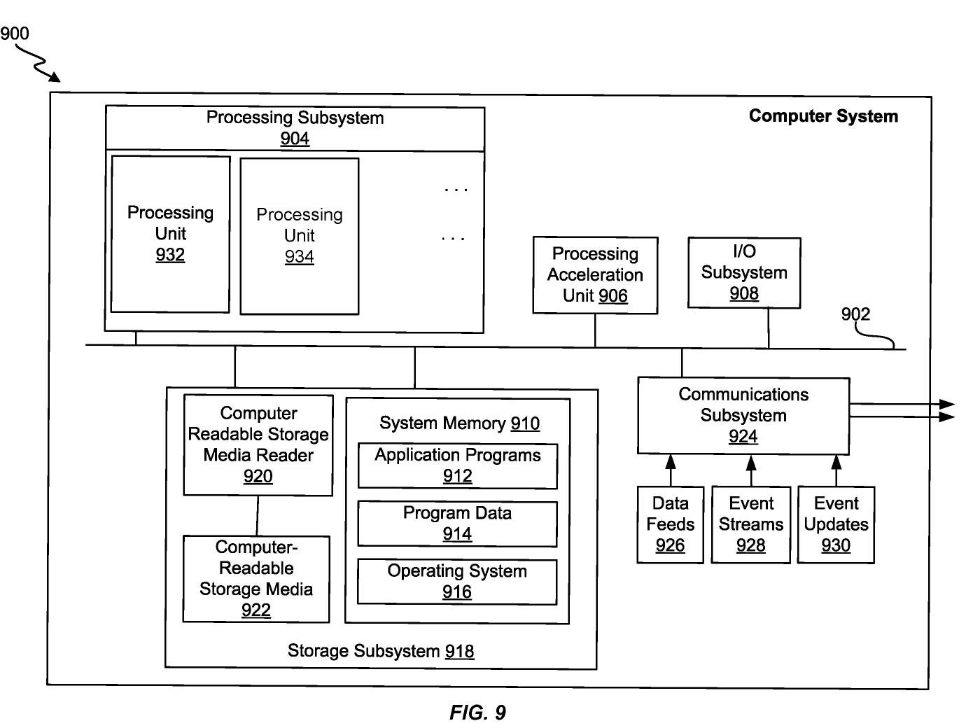

FIG. 9 illustrates a computer system 900 that may be used to implement certain aspects. As shown in FIG. 9, computer system 900 includes various subsystems including a processing subsystem 904 that communicates with several other subsystems via a bus subsystem 902. These other subsystems may include a processing acceleration unit 906, an I/O subsystem 908, a storage subsystem 918, and a communications subsystem 924. Storage subsystem 918 may include a computer-readable storage media reader 920, a computer-readable storage media 922, and a system memory 910.

Bus subsystem 902 provides a mechanism for letting the various components and subsystems of computer system 900 communicate with each other as intended. Although bus subsystem 902 is shown schematically as a single bus, alternative aspects of the bus subsystem may utilize multiple buses. Bus subsystem 902 may be any of several types of bus structures including a memory bus or memory controller, a peripheral bus, a local bus using any of a variety of bus architectures, and the like. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1396.1 standard, and the like.

Processing subsystem 904 controls the operation of computer system 900 and may comprise one or more processors, application specific integrated circuits (ASICs), or field programmable gate arrays (FPGAs). The processors may be single core or multicore processors. The processing resources of computer system 900 can be organized into one or more processing units 932, 934, etc. A processing unit may include one or more processors, one or more cores from the same or different processors, a combination of cores and processors, or other combinations of cores and processors. In some aspects, processing subsystem 904 can include one or more special purpose co-processors such as graphics processors, digital signal processors (DSPs), or the like. In some aspects, some or all the processing units of processing subsystem 904 can be implemented using customized circuits, such as application specific integrated circuits (ASICs), or field programmable gate arrays (FPGAs).

In some aspects, the processing units in processing subsystem 904 can execute instructions stored in system memory 910 or on computer-readable storage media 922. In various aspects, the processing units can execute a variety of programs or code instructions and can maintain multiple concurrently executing programs or processes. At any given time, some or all the program code to be executed can be resident in system memory 910 and/or on computer-readable storage media 922 including potentially on one or more storage devices. Through suitable programming, processing subsystem 904 can provide various functionalities described above. In instances where computer system 900 executes one or more virtual machines, one or more processing units may be allocated to each virtual machine.

In certain aspects, a processing acceleration unit 906 may optionally be provided for performing customized processing or for off-loading some of the processing performed by processing subsystem 904 to accelerate the overall processing performed by computer system 900.

I/O subsystem 908 may include devices and mechanisms for inputting information into computer system 900 and/or for outputting information from or via computer system 900. In general, use of the term input device is intended to include all types of devices and mechanisms for inputting information into computer system 900. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices such as the Meta Quest® controller, Microsoft Kinect® motion sensor, the Microsoft Xbox® 360 game controller, or devices that provide an interface for receiving input using gestures and spoken commands. User interface input devices may also include eye gesture recognition devices such as a blink detector that detects eye activity (e.g., "blinking" while taking pictures and/or making a menu selection) from users and transforms the eye gestures as inputs to an input device. Additionally, user interface input devices may include voice recognition sensing devices that enable users to interact with voice recognition systems (e.g., Siri® navigator or Amazon Alexa®) through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, QR code readers, barcode readers, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments, and the like.

In general, the use of the term output device is intended to include all types of devices and mechanisms for outputting information from computer system 900 to a user or other computer. User interface output devices may include a display subsystem, indicator lights, or non-visual displays such as audio output devices, etc. The display subsystem may be any device for outputting a digital picture. Example display devices include flat panel display devices such as those using a light emitting diode (LED) display, a liquid crystal display (LCD) or plasma display, a projection device, a touch screen, a desktop or laptop computer monitor, and the like. As another example, wearable display devices such as Meta Quest® or Microsoft HoloLens® may be mounted to the user for displaying information. User interface output devices may include, without limitation, a variety of display devices that visually convey text, graphics, and audio/video information such as monitors, printers, speakers, headphones, automotive navigation systems, plotters, voice output devices, and modems.

Storage subsystem 918 provides a repository or data store for storing information and data that is used by computer system 900. Storage subsystem 918 provides a tangible non-transitory computer-readable storage medium for storing the basic programming and data constructs that provide the functionality of some aspects. Storage subsystem 918 may store software (e.g., programs, code modules, instructions) that when executed by processing subsystem 904 provides the functionality described above. The software may be executed by one or more processing units of processing subsystem 904. Storage subsystem 918 may also provide a repository for storing data used in accordance with the teachings of this disclosure.

Storage subsystem 918 may include one or more non-transitory memory devices, including volatile and non-volatile memory devices. As shown in FIG. 9, storage subsystem 918 includes a system memory 910 and a computer-readable storage media 922. System memory 910 may include several memories including a volatile main random-access memory (RAM) for storage of instructions and data during program execution and a non-volatile read only memory (ROM) or flash memory in which fixed instructions are stored. In some implementations, a basic input/output system (BIOS), containing the basic routines that help to transfer information between elements within computer system 900, such as during start-up, may typically be stored in the ROM. The RAM typically contains data and/or programming modules that are presently being operated and executed by processing subsystem 904. In some implementations, system memory 910 may include multiple several types of memory, such as static random-access memory (SRAM), dynamic random-access memory (DRAM), and the like.

By way of example, and not limitation, as depicted in FIG. 9, system memory 910 may load application programs 912 that are being executed, which may include various applications such as Web browsers, mid-tier applications, relational database management systems (RDBMS), etc., program data 914, and an operating system 916. By way of example, operating system 916 may include various versions of Microsoft Windows®, Apple Macintosh®, and/or Linux® operating systems, a variety of commercially-available UNIX® or UNIX-like operating systems (including without limitation the variety of GNU/Linux operating systems, the Oracle Linux®, Google Chrome® OS, and the like) and/or mobile operating systems such as iOS, Windows® Phone, Android® OS, and others.

Computer-readable storage media 922 may store programming and data constructs that provide the functionality of some aspects. Computer-readable storage media 922 may provide storage of computer-readable instructions, data structures, program modules, and other data for computer system 900. Software (programs, code modules, instructions) that, when executed by processing subsystem 904 provides the functionality described above, may be stored in storage subsystem 918. By way of example, computer-readable storage media 922 may include non-volatile memory such as a hard disk drive, a magnetic disk drive, an optical disk drive such as a CD ROM, digital video disc (DVD), a Blu-Ray® disk, or other optical media. Computer-readable storage media 922 may include Zip® drives, flash memory cards, universal serial bus (USB) flash drives, secure digital (SD) cards, DVD disks, digital video tape, and the like. Computer-readable storage media 922 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, dynamic random access memory (DRAM)-based SSDs, magneto-resistive RAM (MRAM) SSDs, and hybrid SSDs that use a combination of DRAM and flash memory based SSDs.

In certain aspects, storage subsystem 918 may also include a computer-readable storage media reader 920 that can further be connected to computer-readable storage media 922. The computer-readable storage media reader 920 may receive and be configured to read data from a memory device such as a disk, a flash drive, etc.

In certain aspects, computer system 900 may support virtualization technologies, including virtualization of processing and memory resources. For example, computer system 900 may provide support for executing one or more virtual machines. In certain aspects, computer system 900 may execute a program such as a hypervisor that facilitates the configuration and management of the virtual machines. Each virtual machine may be allocated memory, computer (e.g., processors, cores), I/O, and networking resources. Each virtual machine runs independently of the other virtual machines. A virtual machine typically runs its own operating system, which may be the same as or different from the operating systems executed by other virtual machines executed by computer system 900. Accordingly, multiple operating systems may potentially be run concurrently by computer system 900.

Communications subsystem 924 provides an interface to other computer systems and networks. Communications subsystem 924 serves as an interface for receiving data from and transmitting data to other systems from computer system 900. For example, communications subsystem 924 may enable computer system 900 to establish a communication channel to one or more client devices via the Internet for receiving and sending information from and to the client devices. For example, the communications subsystem may be used to transmit a response to a user regarding the inquiry for a chatbot.

Communications subsystem 924 may support both wired and/or wireless communication protocols. For example, in certain aspects, communications subsystem 924 may include radio frequency (RF) transceiver components for accessing wireless voice and/or data networks (e.g., using cellular telephone technology, advanced data network technology, such as 3G, 4G or EDGE (enhanced data rates for global evolution), Wi-Fi (IEEE 902.XX family standards, or other mobile communication technologies, or any combination thereof), global positioning system (GPS) receiver components, and/or other components. In some aspects, the communications subsystem 924 can provide wired network connectivity (e.g., Ethernet) in addition to or instead of a wireless interface.

Communications subsystem 924 can receive and transmit data in various forms. For example, in some aspects, in addition to other forms, communications subsystem 924 may receive input communications in the form of data feeds 926 that may be structured and/or unstructured, event streams 928, event updates 930, and the like. For example, communications subsystem 924 may be configured to receive (or send) data feeds 926 in real-time from users of social media networks and/or other communication services such as Twitter® feeds, Facebook® updates, web feeds such as Rich Site Summary (RSS) feeds, and/or real-time updates from one or more third party information sources.

In certain aspects, communications subsystem 924 may be configured to receive data in the form of continuous data streams, which may include event streams 928 of real-time events and/or event updates 930, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 924 may also be configured to communicate data from computer system 900 to other computer systems or networks. The data may be communicated in various forms such as structured and/or unstructured data feeds, event streams 928, event updates 930, and the like to one or more databases that may be in communication with one or more streaming data source computers coupled to computer system 900.

Computer system 900 can be one of various types, including a handheld portable device (e.g., an iPhone® cellular phone, an iPad® computing tablet, a personal digital assistant (PDA)), a wearable device (e.g., a Meta Quest® head mounted display), a personal computer, a workstation, a mainframe, a kiosk, a server rack, or any other data processing system. Due to the ever-changing nature of computers and networks, the description of computer system 900 depicted in FIG. 9 is intended only as a specific example. Many other configurations having more or fewer components than the system depicted in FIG. 9 are possible. Based on the disclosure and teachings provided herein, a person of ordinary skill in art can appreciate other ways and/or methods to implement the various aspects.

Although specific aspects have been described, various modifications, alterations, alternative constructions, and equivalents are possible. Embodiments are not restricted to operation within certain specific data processing environments but are free to operate within a plurality of data processing environments. Additionally, although certain aspects have been described using a particular series of transactions and steps, it should be apparent to those skilled in the art that this is not intended to be limiting. Although some flowcharts describe operations as a sequential process, many of the operations can be performed in parallel or concurrently. In addition, the order of the operations may be rearranged. A process may have additional steps not included in the figure. Various features and aspects of the above-described aspects may be used individually or jointly.

Further, while certain aspects have been described using a particular combination of hardware and software, it should be recognized that other combinations of hardware and software are also possible. Certain aspects may be implemented only in hardware, or only in software, or using combinations thereof. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation, such as by executing computer instructions or code, or processors or cores programmed to execute code or instructions stored on a non-transitory memory medium, or any combination thereof. Processes can communicate using a variety of techniques including conventional techniques for inter-process communications, and different pairs of processes may use different techniques, or the same pair of processes may use different techniques at various times.

Specific details are given in this disclosure to provide a thorough understanding of the aspects. However, aspects may be practiced without these specific details. For example, well-known circuits, processes, algorithms, structures, and techniques have been shown without unnecessary detail to avoid obscuring the aspects. This description provides example aspects only, and is not intended to limit the scope, applicability, or configuration of other aspects. Rather, the preceding description of the aspects can provide those skilled in the art with an enabling description for implementing various aspects. Various changes may be made in the function and arrangement of elements.

The specifications and drawings are, accordingly, to be regarded in an illustrative rather than a restrictive sense. It can, however, be evident that additions, subtractions, deletions, and other modifications and changes may be made thereunto without departing from the broader spirit and scope as set forth in the claims. Thus, although specific aspects have been described, these are not intended to be limiting. Various modifications and equivalents are within the scope of the following claims.

What is claimed:

1. A computer-implemented method comprising:
creating a data ingestion layer to store and map data, wherein creating the ingestion layer includes:
mapping, at runtime, a resource ID to a server endpoint in a meta database,
parsing the data and detecting a plurality of duplicate resources among the data,
validating the data stored in the meta database,
defining a plurality of APIs (Application Programming Interfaces) for a plurality of resources at an API gateway,
registering a plurality of errors as follow up actions for a user, and
storing and updating the plurality of APIs in the meta database;
rerouting a request from a first server endpoint to a second server endpoint, by:
receiving the request from the user,
authenticating the request at the API gateway,
retrieving an API of a resource associated with the request from the meta database,
retrieving mapping and a plurality of policies associated with the request, from the meta database, and
based on the mapping and the plurality of policies, rerouting the request and returning a response;
automating processing of the request using a machine learning engine; and
displaying the plurality of resources and corresponding services on a user interface.

2. The computer-implemented method of claim 1, wherein the meta database is a centralized storage for consolidating the plurality of APIs of the plurality of resources that are present nation-wide.

3. The computer-implemented method of claim 1, wherein parsing the data and detecting the plurality of duplicate resources is done using algorithms like prefix-based search, fuzzy matching, and/or full string matching.

4. The computer-implemented method of claim 1, wherein the resource manages its services using the plurality of policies and APIs stored at the meta database.

5. The computer-implemented method of claim 1, wherein the user interface allows the user to choose from:
a plurality of server endpoints;
the plurality of resources that are associated with/outside of a cloud network; and
a plurality of services of the plurality of resources.

6. The computer-implemented method of claim 1, wherein the user interface allows the server endpoint to choose from:
the plurality of resources working with an organization; and
a plurality of service plans of a plurality of server endpoints.

7. The computer-implemented method of claim 1, wherein the machine learning engine processes the request and optimizes a plurality of services plans according to a user’s preferences by using:
the plurality of policies corresponding to the request;
a plurality of confidence metrices associated with a plurality of server endpoints and the plurality of resources; and
feedback of the user stored in a historical database.

8. A system comprising:
one or more processors;
one or more non-transitory computer-readable media storing instructions, which, when executed by the system, cause the system to perform a set of actions comprising:
creating a data ingestion layer to store and map data, wherein creating the ingestion layer includes:
mapping, at runtime, a resource ID to a server endpoint in a meta database,
parsing the data and detecting a plurality of duplicate resources among the data,
validating the data stored in the meta database,
defining a plurality of APIs (Application Programming Interfaces) for a plurality of resources at an API gateway,
registering a plurality of errors as follow up actions for a user, and
storing and updating the plurality of APIs in the meta database;
rerouting a request from a first server endpoint to a second server endpoint, by:
receiving the request from the user,
authenticating the request at the API gateway,
retrieving an API of a resource associated with the request from the meta database,
retrieving mapping and a plurality of policies associated with the request, from the meta database, and
based on the mapping and the plurality of policies, rerouting the request and returning a response;
automating processing of the request using a machine learning engine; and
displaying the plurality of resources and corresponding services on a user interface.

9. The system of claim 8, wherein the meta database is a centralized storage for consolidating the plurality of APIs of the plurality of resources that are present nation-wide.

10. The system of claim 8, wherein parsing the data and detecting the plurality of duplicate resources is done using algorithms like prefix-based search, fuzzy matching, and/or full string matching.

11. The system of claim 8, wherein the resource manages its services using the plurality of policies and APIs stored at the meta database.

12. The system of claim 8, wherein the user interface allows the user to choose from:
a plurality of server endpoints;
the plurality of resources that are associated with/outside of a cloud network; and
a plurality of services of the plurality of resources.

13. The system of claim 8, wherein the user interface allows the server endpoint to choose from:
the plurality of resources working with an organization; and
a plurality of service plans of a plurality of server endpoints.

14. A computer-program product tangibly embodied in a non-transitory machine-readable storage medium, including instructions configured to cause one or more data processors to perform a set of actions comprising:
creating a data ingestion layer to store and map data, wherein creating the ingestion layer includes:
mapping, at runtime, a resource ID to a server endpoint in a meta database,
parsing the data and detecting a plurality of duplicate resources among the data,
validating the data stored in the meta database,
defining a plurality of APIs (Application Programming Interfaces) for a plurality of resources at an API gateway,
registering a plurality of errors as follow up actions for a user, and
storing and updating the plurality of APIs in the meta database;
rerouting a request from a first server endpoint to a second server endpoint, by:
receiving the request from the user,
authenticating the request at the API gateway,
retrieving an API of a resource associated with the request from the meta database,
retrieving mapping and a plurality of policies associated with the request, from the meta database, and
based on the mapping and the plurality of policies, rerouting the request and returning a response;
automating processing of the request using a machine learning engine; and
displaying the plurality of resources and corresponding services on a user interface.

15. The computer-program product of claim 14, wherein the meta database is a centralized storage for consolidating the plurality of APIs of the plurality of resources that are present nation-wide.

16. The computer-program product of claim 14, wherein parsing the data and detecting the plurality of duplicate resources is done using algorithms like prefix-based search, fuzzy matching, and/or full string matching.

17. The computer-program product of claim 14, wherein the resource manages its services using the plurality of policies and APIs stored at the meta database.

18. The computer-program product of claim 14, wherein the user interface allows the user to choose from:
a plurality of server endpoints;
the plurality of resources that are associated with/outside of a cloud network; and
a plurality of services of the plurality of resources.

19. The computer-program product of claim 14, wherein the user interface allows the server endpoint to choose from:
the plurality of resources working with an organization; and
a plurality of service plans of a plurality of server endpoints.

20. The computer-program product of claim 14, wherein the machine learning engine processes the request and optimizes a plurality of services plans according to a user’s preferences by using:
the plurality of policies corresponding to the request;
a plurality of confidence metrices associated with a plurality of server endpoints and the plurality of resources; and
feedback of the user stored in a historical database.
